(19) United States
(12) Patent Application Publication
(10) Pub. No.: US 2016/0292369 A1
(43) Pub. Date: Oct. 6, 2016

(54) Methods and Apparatus for Scheduling Optimization and Preferences Resolution Automation with No Show Overbooking

(71) Applicant: Radix Health LLC, Marietta, GA (US)

(72) Inventors: Anup Lakare, Atlanta, GA (US); Vishv Jeet, Marietta, GA (US); Arun Mohan, Atlanta, GA (US); Ravindra Jore, Pune (IN)

(21) Appl. No.: 14/675,933

(22) Filed: Apr. 1, 2015

(51) Int. Cl. G06F 19/00

(52) U.S. Cl. CPC G06F 19/327; G06F 19/322

(57) ABSTRACT

An automated process to create and schedule an appointment is described that patients can use themselves for booking a doctor appointment, cancellation, rebooking, and the like. The approaches described herein make a large step in the direction of completely automating scheduling appointments of service by service users with service providers thereby eliminating most manual intervention.

### FIELD OF INVENTION

The present invention addresses an improved scheduling system generally, and more particularly, improved methods and apparatus for dynamically ranking appointment slots that ranks the available slots taking into account a given client's preferences along with service provider's preferences, as well as, scheduling configurations and resource constraints.

### BACKGROUND OF THE INVENTION

It would be hard to find a person who has never become frustrated with scheduling a service provider, such as a dentist or a doctor appointment. It can be a difficult process to get an appointment with a doctor. For example, first one has to figure out if his or her insurance coverage is applicable. Then, it is necessary to find a doctor that is covered by that insurance and is close to your home or office and then call up the receptionist to set up an appointment for you. While on phone it may take a long time to find a slot that matches your schedule, preferences, and urgency, with a doctor's schedule and preferences. The time slot matching is quite complicated and there is a substantial need of a scheduling system that will at least partially automate the scheduling system.

When you ask for an appointment to see a specialist, you are requested to wait to two weeks or even a month. Such delay may occur because appointment secretaries usually find it easier to look out into the future where a doctor's schedule has plenty of openings. Both manual and automatic slot generation and matching are very complicated involving a long list of complications that need to be resolved before an appointment can be made. In the manual approach, the medical agent (MA) who is setting up an appointment has to go through a large number of preferences and schedule templates that doctors maintain. A typical doctor, per week, may visit five to six different facilities and hospitals during different times of day. In addition, they may have preferences regarding what kind of patients they would like to see during an open time slot on a given day and at a given facility. For example, a doctor may instruct his or her medical assistant to accept a maximum of six patients on Monday morning. The group of six patients comprising half new and half old patients, in that order. Further, those patients may be required to be under the age of 50 years old and have only certain types of ailments. Further, they may be required not to have other complications such as history of H1NI flu or certain other diseases at a current time. Patients may also be filtered based on insurance coverage. For example, a patient without insurance (mercy care) can be scheduled on only certain downtimes in the week or month.

U.S. Pat. No. 8,671,009 by Coley et al. also describes aspects of on-line scheduling and other resources and is incorporated by reference herein in its entirety. U.S. Pat. No. 8,688,466 by Kharraz Tavakol et al. also describes aspects of data synchronization for booking of healthcare appointments and is incorporated by reference herein in its entirety.

A further complication in the scheduling problem arises from the fact that different patients (age, gender, ailment type, race, language, education, financial status, married or unmarried, with or without kids, with or without employment, religious preferences, insurance coverage, history of ailments, and other complicating/simultaneous diseases etc.) may require a different number of minutes to be scheduled. In addition to all the above, there is yet another important complicating factor. That factor is the probability of no show and cancellations. In any practice, a certain percentage of patients after scheduling the appointment either do not show up or call to cancel prior to the day of the scheduled appointment. As such, there is no opportunity to fill in the now available slot. As many as 15% of patients either cancel their appointments at the last minute or simply do not show up.

See also an academic paper on no show and cancellations “Clinic Overbooking to Improve Patient Access and Increase Provider Productivity” by Linda R. LaGanga and Stephen R. Lawrence, in Decision Sciences, Volume 38, Number 2, May 2007 (Journal compilation C 2007, Decision Sciences Institute) that describes various factors of no shows phenomenon in clinics and its impact on provider productivity and is incorporated by reference herein in their entirety.

Existing scheduling systems have several issues with them including they are mostly calendar based systems which makes them manual to begin with and most of these systems are not able to generate slots of varying length. It is not surprising that while each patient requires a different amount of time with the doctor, most software approaches find it easier to implement fixed length slots because there is no way to know what dynamic slot length must be used. Finally, most software systems do not have access to or ability to read doctors preferences because of the non-standard format typically employed, such as hand written notes to personal medical assistants. Patient side preferences are resolved manually on phone or in person usually with patients compromising on their schedule by either delaying an appointment, working around an inconvenient time, or the like.

### SUMMARY OF THE INVENTION

In one aspect of the invention, a process is employed that can drastically reduce the appointment scheduling time by automatic application of doctors' preferences and schedule on phone or internet and also provide better slots to patients and fills the unused and hard to find slots in near future and risky slots that are likely to be cancelled or subject to no shows.

Among its several aspects, the present invention recognizes that it would be highly desirable to have medical appointment slot generation and filtering based on preferences of patients and doctors, as well as, applying constraints and preferences that facilities or medical business may maintain to drive the business in a desired direction.

Among its several aspects, the present invention recognizes that in existing scheduling systems preferences and slot lengths are often resolved manually. Thus, these scheduling systems provide available slots of fixed length that may partially resolve the preferences based upon manual decision making. As a result, the individuals in the system doctors, MAs, and patients are in a constant tug of war, and it is impossible to determine if or where things are going wrong, and what decisions have helped or hurt performance of a business or a given facility.

The present invention describes a new appointment scheduling approach adapted to the context of a medical practice in which the slot length is altered for every patient so that, it betters suits the patient's requirement of time with the doctor. The doctor's and patient's preferences are resolved by a computer program using a ranking approach to push the better matched slots up. This approach also has provision for applying facility level and/or overall business level constraints and configurations.

Among its several aspects, the present invention further recognizes that, in existing medical appointment scheduling approaches doctors and patients preferences are often resolved manually on fixed length slots and no consideration is given to business or medical facility level constraints or configurations. In addition to the deficiencies described above, existing medical appointment scheduling approaches do not have any built-in mechanism to automatically double book time slots that are likely to be cancelled or subject to no shows.

The present invention overcomes many problems associated with existing systems. In accordance with one aspect of the invention, the slot length is altered as follows. After retrieving a patient's demography and other medical history and information, a regression-based prediction algorithm predicts the slot length suitable for the patient. Once the slot length is known using the patient's preferred doctors and facility combinations, suitable slots are generated and are filtered and ranked based of doctor's, patient's, and facility's preferences and configurations. A predetermined number of slots, such as a top ten list of the highest ranked slots is then presented to a patient to choose. The top ten slots may also include the slots that are already booked, but have the highest risk to go unused either because of cancellation or no shows. This procedure is more detailed than the existing approach and yields more practical and intuitive slots that tend to keep everyone happier. This procedure also provides an opportunity for everyone to express their preferences and constraints.

The present invention recognizes that it is important for the facilities to be able to unify the slot generation process and influence their ranking and percentage of double bookings by adjusting a risk tolerance parameter.

One goal of the present invention, then, is to describe a methodology that enables patients, MAs, as well as, doctors to make use of an automated appointment system all by themselves with a few simple computer clicks.

A more complete understanding of the present invention, as well as further features and advantages of the invention, will be apparent from the following Detailed Description and the accompanying drawings.

### BRIEF DESCRIPTION OF THE DRAWINGS

FIG. 1 shows a computer based system which may be suitably utilized to implement the present invention;

FIG. 2 shows a table of information suitably used in a decision making process and slot assignment computation taking into effect the probability of no show and cancellation an appointment with doctor in accordance with the present invention;

FIG. 3 illustrates how multiple doctors' preferences can be tabled for automatic processing by a computer program;

FIG. 4 illustrates a how multiple doctors' schedule books can be tabled for automatic processing by a computer program;

FIG. 5 illustrates a how patient's information to compute no show and cancellation probabilities and interplay with doctors' schedule and preferences can be tabled for automatic processing by a computer program;

FIG. 6 illustrates a how multiple doctors' scheduling configurations can be tabled for automatic processing by a computer program;

FIG. 7 illustrates a how multiple doctors' scheduling constraints on maximum number of patients and maximum number of urgent cases—they would like to see on their schedule—can be tabled for automatic processing by a computer program;

FIG. 8 illustrates a how facility level scheduling configurations can be tabled for automatic processing by a computer program;

FIG. 9 illustrates a how multiple doctors' available and processes slots (booked or empty) at multiple facilities are tabled and produces by a computer program to be presented to patient to choose from; and

FIG. 10 illustrates an overall scheduling process in accordance with the present invention.

### DETAILED DESCRIPTION

The present invention may be suitably implemented as a computer based system, in computer software which is stored in a non-transitory manner and which may suitably reside on computer readable media, such as solid state storage devices, such as RAM, ROM, or the like, magnetic storage devices such as a hard disk or solid state drive, optical storage devices, such as CD-ROM, CD-RW, DVD, Blue Ray Disc or the like, or as methods implemented by such systems and software. The present invention may be implemented on personal computers, workstations, computer servers or mobile devices such as cell phones, tablets, IPads™, IPods™ and the like.

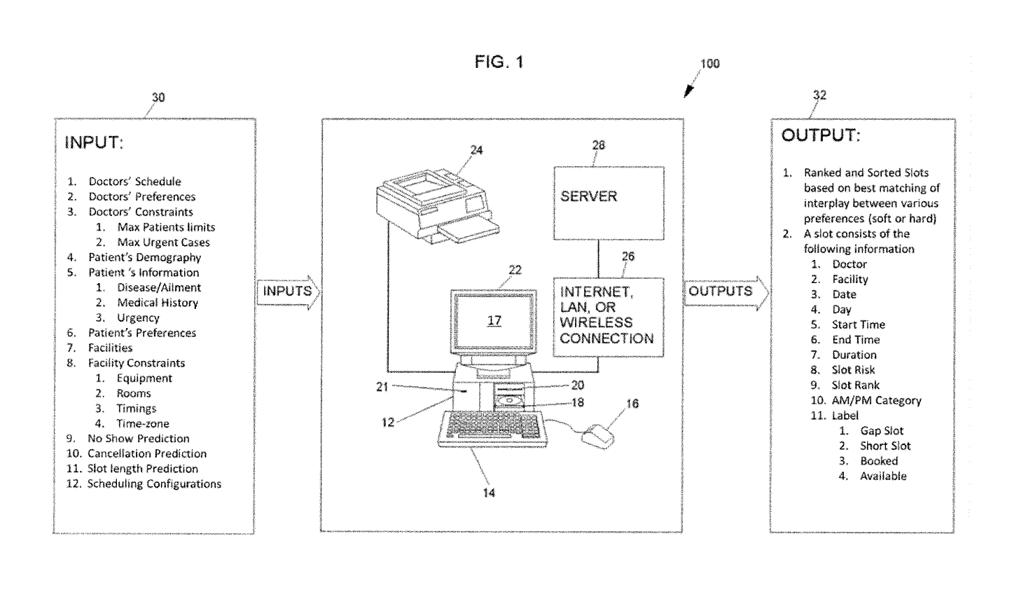

FIG. 1 shows a block diagram of a computer system 100 which may be suitably used to implement the present invention. System 100 is implemented as a computer or mobile device 12 including one or more programmed processors, such as a personal computer, workstation, or server. One likely scenario is that the system of the invention will be implemented as a personal computer or workstation which connects to a server 28 or other computer through an Internet, local area network (LAN) or wireless connection 26. In this embodiment, both the computer or mobile device 12 and server 28 run software that when executed enables the user to input instructions and calculations on the computer or mobile device 12, send the input for conversion to output at the server 28, and then display the output on a display, such as display 22, or print the output, using a printer, such as printer 24, connected to the computer or mobile device 12. The output could also be sent electronically through the Internet, LAN, or wireless connection 26. In another embodiment of the invention, the entire software is installed and runs on the computer or mobile device 12, and the Internet connection 26 and server 28 are not needed.

As shown in FIG. 1 and described in further detail below, the system 100 includes software that is run by the central processing unit of the computer or mobile device 12. The computer or mobile device 12 may suitably include a number of standard input and output devices, including a keyboard 14, a mouse 16, a touch screen 17, CD-ROM/CD-RW/DVD drive 18, disk drive or solid state drive 20, monitor 22, and printer 24. The computer or mobile device 12 may also have a USB connection 21 which allows external hard drives, flash drives and other devices to be connected to the computer or mobile device 12 and used when utilizing the invention.

It will be appreciated, in light of the present description of the invention, that the present invention may be practiced in any of a number of different computing environments without departing from the spirit of the invention. For example, the system 100 may be implemented in a network configuration with individual workstations connected to a server. Also, other input and output devices may be used, as desired. For example, a remote user could access the server with a desktop computer, a laptop utilizing the Internet or with a wireless handheld device such as cell phones, tablets and e-readers such as an IPad™, IPhone™, IPod™, Blackberry™, Treo™, or the like.

One embodiment of the invention has been designed for use on a stand-alone personal computer running in Windows 7. Another embodiment of the invention has been designed to run on a Linux-based server system. The present invention may be coded in a suitable programming language or programming environment such as Java, C++, Excel, R, Matlab, Python, etc.

According to one aspect of the invention, it is contemplated that the computer or mobile device 12 will be operated by a user in a doctor's office, out-patient care facility, hospital, or home setting.

As illustrated in FIG. 1, and as described in greater detail below, the inputs 30 may suitably include doctors' schedules across multiple facilities, doctor preferences and constraints, patients' information and demographics, patients' preferences, scheduling configurations, no show and cancellation probabilities, slot length prediction, and the like.

As further illustrated in FIG. 1, and as described in greater detail below, the system outputs 32 may suitably include a list of generated slots of predicted or pre-specified length, and their ranking. Each slot may suitably comprise the specification of a doctor, facility, day, date, start time, end time, slot length or duration, slot risk, slot rank, and a slot label.

The output information may appear on a display screen of the monitor 22 or may also be printed out at the printer 24. The output information may also be electronically sent to an intermediary for interpretation. For example, the generated and ranked slots can be grouped or sorted differently prior to being offered to an individual seeking to make a reservation. Other devices and techniques may also advantageously be used to provide outputs, as desired.

It would be hard to find a person who has never been to a doctor. It is almost no wonder when you ask for an appointment to see a specialist you are requested to wait up to two weeks or even a month. Such waits may be because appointment secretaries usually find it easier to look into the future where a doctor's schedule has multiple openings. We all also know how hard it is to get an appointment with a doctor, first you have to figure out if your insurance coverage applies. Then one has to find a doctor that is covered and is preferably close to one's home or office. Then it is typically necessary to call up the doctor's receptionist to set up an appointment. While on the phone, it may take long time to find a slot that matches your schedule, urgency, and the doctor's schedule, including all of his or her scheduling constraints.

The slot matching is much more complicated than the typical patient or client knows. There may be a long list of constraints that need resolution before an appointment can be scheduled. The person who is setting up an appointment for you often has to go through a long list of preferences and schedule templates that doctors maintain. A typical doctor, per week, may visit five to six different facilities and hospitals during different times of day. In addition, they may have preferences regarding what kind of patients they would like to see during an open time slot on a given day and at a given facility. For example, a doctor may instruct his or her medical assistant to accept a maximum of six patients on Monday morning. This group may be limited to half new and half old patients in that order. Further, those patients may be required to be under the age of 50 years and have had only certain types of ailments. They may be further be required not to have other complications such as history of H1NI flu or certain simultaneous diseases. Patients may also be filtered based on insurance coverage. For example, a patient without insurance (mercy care) can be scheduled on only certain downtimes in the week or month.

Further complication in scheduling may arise from the fact that different patients (age, gender, ailment type, race, language, education, financial status, married or unmarried, with or without kids, with or without employment, religious preferences, insurance coverage, history of ailments, and other complicating/simultaneous diseases etc.) may require a different number of minutes to be scheduled. In addition to all of the above, there is another significant factor: the probability of no show and late cancellations. A certain percentage of patients after scheduling the appointment either do not show up or call up on the day of appointment that they do not need to see the doctor anymore. As much as 15% of patients either cancel their appointments or simply do not show up.

As a result, the present invention addresses the need for a scheduling system that will at least partially automate the scheduling system and refill the slots that are either likely to go unused because of high probability of no show or late cancellation. To this end, a dynamic slot ranking approach is employed that ranks the available slots for a given patient based on patient preference in terms of day, time of day, gender of doctor, list of facilities etc. and the ranked available slots are listed. This approach can, not only reduce the appointment scheduling time spent on the phone, but also provides better slots to patients and fills the unused (hard to find slots) slots in the near future.

A slot generation and ranking process in accordance with the present invention starts with reading the template of schedule for a chosen set of doctors and facilities and builds an inventory of available slots (both empty and booked). If the patient's preferences do not include a doctor and facility, and typically a new patient may not have those preferences, then doctors and facilities are chosen using an auxiliary sorted list to suggest possible preferences based on a round robin based or utility based sorting. Empty slots are assigned a probability 1.0 that a patient will not show up and booked slots are assigned the respective patient's predicted probability of no show. The slots in this inventory are than ranked higher or lower one at a time depending upon slot doctor's preferences. A slot may suitably comprise some or all of the following information:

1) Slot Doctor

2) Slot Facility

3) Slot day

4) Slot date

5) Start Time

6) End time

7) Slot duration in minutes

8) Slot Category (Early AM, Late AM, Early PM, Late PM)

9) No Show Risk

10) Status (booked, empty, short slot, gap slot)

11) Slot Rank

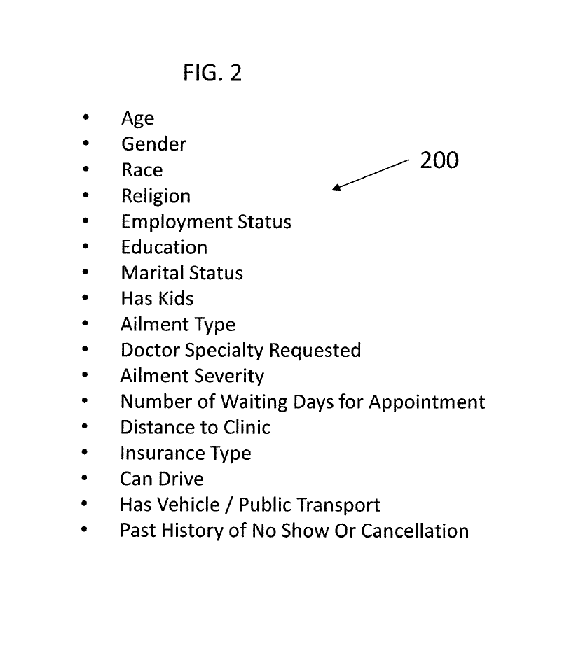

Table 200 of FIG. 2 shows a list of explanatory factors to predict using linear regression a slot length required for the patient's appointment call. A very similar set of factors is also used to predict no show and cancellation probabilities in two separate regressions. To predict whether or not a patient will show up for the appointment regression models are employed using three different models Logit, Probit, and Poisson. The Google eBook with the title “Interpreting Probability Models: Logit, Probit, and Other Generalized Linear Models”, Issue 101, provides further details regarding such models and is incorporated by reference herein in its entirety.

These models allow for binary response variable (1 for show and 0 for no show) and explanatory variables are many including those listed in Table 200. A regression model is preferably employed to efficiently predict whether or not a given patient is in a dangerous range of probability of not showing up and/or cancellation. The predicted probability that a given patient will not show is in the present invention in a process to suggest slots where other patients who are also unlikely to show up are already booked. In this way, the total probability for a slot that a patient will show up is boosted.

The explanatory variables in Table 200 of FIG. 2 can also be used for slot length prediction similar to building a regression model for no show prediction. Another linear regression model is utilized to predict how much time a given patient will need with a doctor. See the book titled “Introduction to Linear Regression Analysis” by Douglas C. Montgomery, Elizabeth A. Peck, G. Geoffrey Vining published by John Wiley & Sons, Apr. 9, 2012—Mathematics—645 pages which is incorporated by reference herein in its entirety, for a detailed description on building suitable linear regression models. The set of factors that can go into this regression can be the same as above only the response variable is changed which is now a continuous variable that counts the number of minutes. See also an academic paper on no show and cancellations “Appointment Scheduling with No-Shows and Overbooking” by Christos Zacharias and Michael Pinedo, in Production and Operations Management, Vol. 23, No. 5, May 2014, pp. 788-801 (ISSN 1059-1478|ETSSN 1937-5956|14|2305|0788), and U.S. Pat. No. 7,693,735 by Carmi et al. which also describes aspects of dynamic schedule estimation both of which are incorporated by reference herein in their entirety.

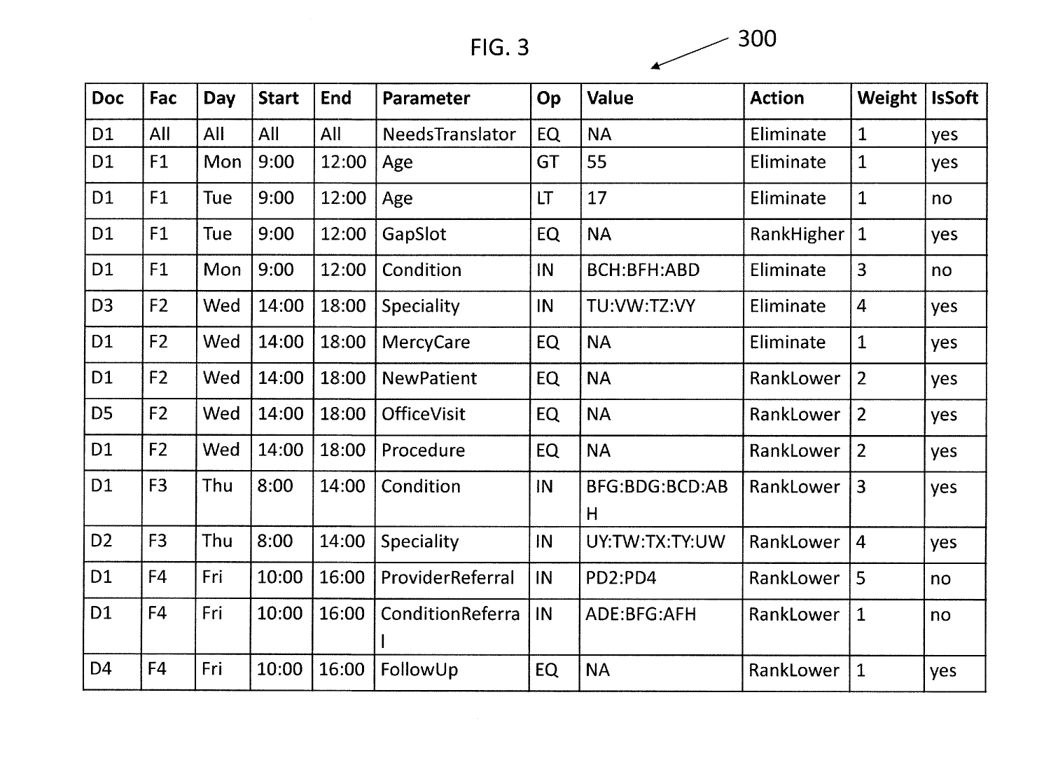

Table 300 of FIG. 3 shows how a typical doctor's preferences may be advantageously arranged in a table format in accordance with the present invention. Most of the standard or combinations of preferences can fit in this format as this is a very generic template where preferences can be translated into rules using a computer program and applied to slot inventory. Preferences can be employed either to remove the slot from the inventory under consideration or to change the ranks given to them using rules (eliminate, rank higher, and rank lower). If a slot matches a preference's day, doctor, facility, start time and end time then slot's rank starting with 1.0 is updated to current value+preferences weight for ranking higher and current value−preferences weight. If the preference is to hard elimination then slot is removed from further consideration otherwise if the preference is soft and slot falls within URGENT_TERM_(specified in Table 600) then it is still ranked. If the slot under consideration is an urgent category (for example within next 3 days) and is likely to go empty and if the eliminate condition is soft, then it can still be ranked instead of being eliminated. Doctors usually don't prefer gaps in their schedule, using the preference table they can specify if they would like to rank gap slots higher to minimize their occurrence. Preferences are specific to day of the week and time on a given day. When ‘All’ is specified, it means the preference applies to all days and times unless specified otherwise for a day and time for a slot under consideration. Doctors can also specify the weights across their preferences so that the ranking of slots is adjusted accordingly. Preferences for multiple doctors and facility combinations can be established in the same table and are read accordingly by a computer program for ranking slots. There are many operators available to build preferences rules including EQ (equal to), NEQ (not equal to), IN (in the specified set), NIN (no IN), GT (greater than or equal to), and LT (less than or equal to).

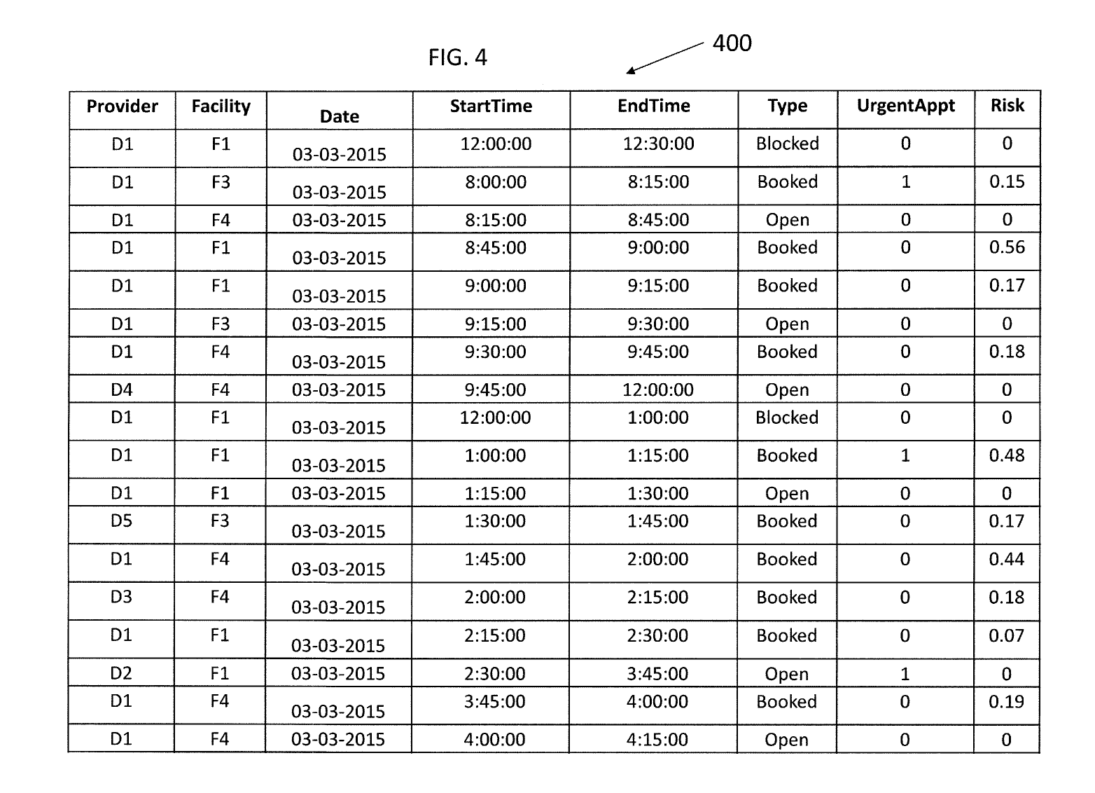

Automated scheduling starts with reading a book of appointments. A typical book for a given doctor on a given day at all facilities looks like book 400 shown in FIG. 4. U.S. Pat. No. 7,904,315 by Sullivan also describes aspects of rules-based health care referral appointments and is incorporated by reference herein in its entirety.

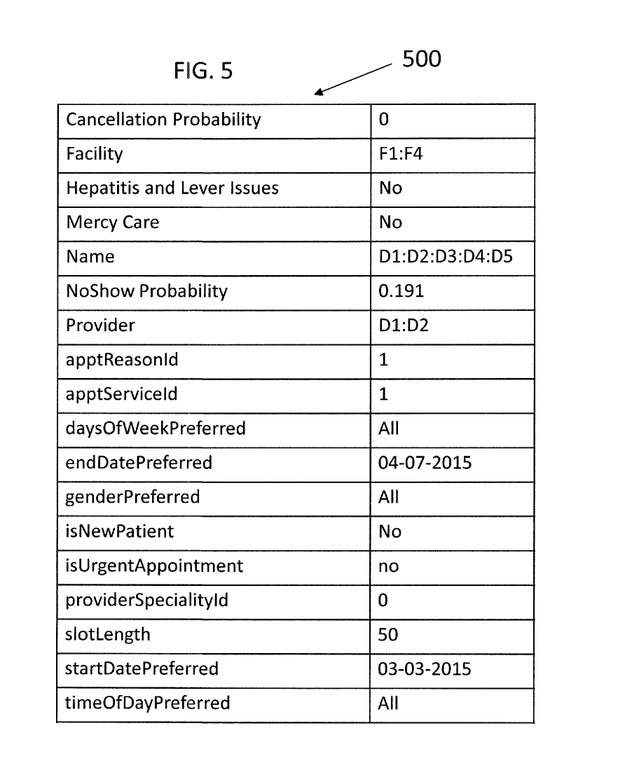

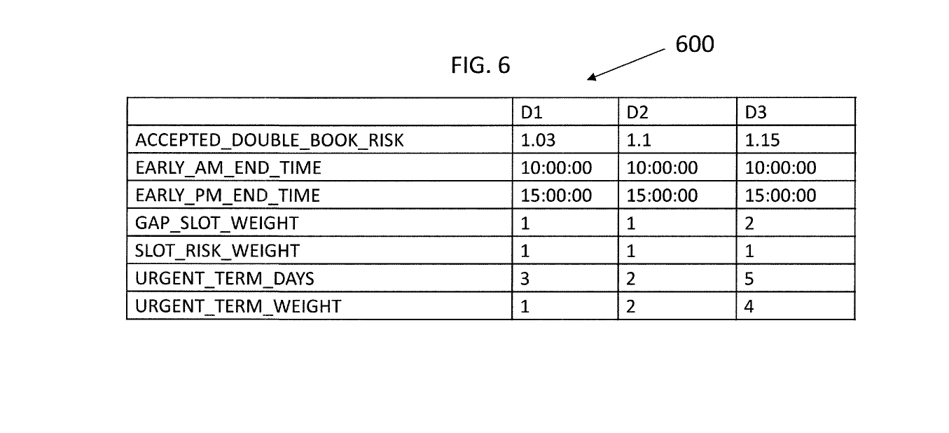

Table 500 of FIG. 5 shows the schedule book across multiple doctors across multiple facilities and Table 600 of FIG. 6 shows the patient's information in the table format a computer program can read.

Using information from table 400 and 700, a computer program generates all available slots of predicted or pre-specified slot length in Table 500. Any slots that do not match a patient's preferences are eliminated right away. If no slots are left, then the patient is requested to relax some of the preferences or slots in further future are generated.

Table 600 of FIG. 6 shows doctor specific scheduling configuration for double booking based on slot risk and configuration for determining if the slots are in urgent category where soft preferences of doctors can be relaxed to fill the slots. Using the patient's preferences and demographical information in Table 500 doctors preferences in Table 300 are applied to rank the available inventory of slots and already booked slots are considered for double booking based on the patient's no show risk and doctors double book preferences specified by (ACCEPTED_DOUBLE_BOOK_RISK) in Table 600. A booked slot's risk is computed using simple sum of no show and cancellation probabilities of existing patient in the slot. The total double book risk for a slot would be the sum of four probabilities, two for no shows and two for cancellations one for each patient already booked and to be booked. For a slot to be double booked total risk should greater than or equal to accepted double book risk specified by the doctor. These risk slots are ranked higher using weight specified by parameter GAP_SLOT_WEIGHT in Table 600. All Slots are also labeled for falling certain AM/PM times using information (EARLY_AM_END_TIME and EARLY_PM_END_TIME) in Table 600. Patients may have preferences around these (Early AM, Late AM, Early PM, and Late PM) based on label assigned to a slot and patients' preferences certain slots may be filtered out. Soft preferences are relaxed for any slot falling within URGENT_TERM_DAYS and are in fact ranked higher for being risky slots likely to go empty using rank higher weight (URGENT_TERM_WEIGHT) specified by provider in Table 600. Any slots that are identified as gaps in doctors scheduled are ranked higher using weights (GAP_SLOT_WEIGHT) specified in Table 600. Any booked slots that have high risk for cancellation are similarly treated.

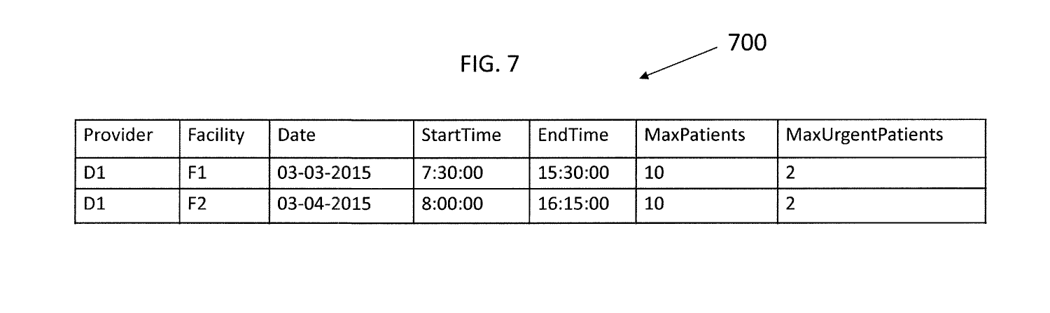

Table 700 of FIG. 7 shows how doctors can also put the following restrictions on their schedule by limiting the maximum number of patients in a given time slot and also put restriction on maximum number of urgent cases they would consider seeing. When an urgent appointment is requested a flag in patient information (Table 500) is turned on and ranking of slots is skipped and all slots (booked or empty) are sorted on their nearness in the future. The only slots that are removed from this list are the one where doctor has already assigned maximum number of urgent cases in her schedule. This information is retrieved from combining information from book (Table 400) and restrictions in Table 700.

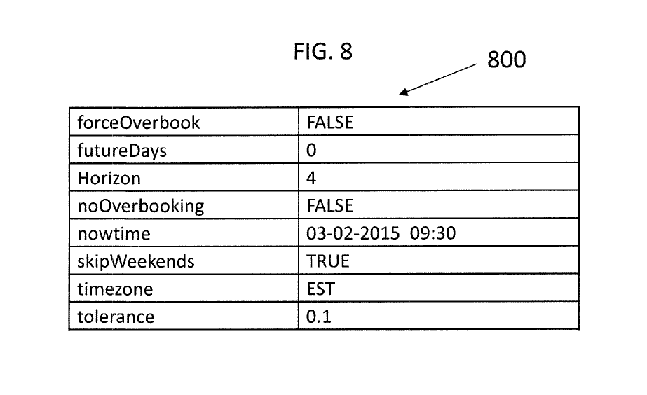

Table 800 of FIG. 8 lists some of the scheduling options that can also be applied to the slot inventory. For example, skip weekends flag when turned on will cause all weekend slots be skipped. No overbooking flag will eliminate all booked slots risky or not. Similarly force overbook flag will eliminate all empty slots and rank only risky booked slots. Horizon is the number of future days in which to search a slot at a time, such as a week, for example. Future days flag is used for making an appointment in certain number of future days. Finally tolerance is a parameter that will be used to rank shorter slots that are within certain tolerance. For example if the 10 minutes slot is requested with 0.1 tolerance then 9 minute slots are also considered.

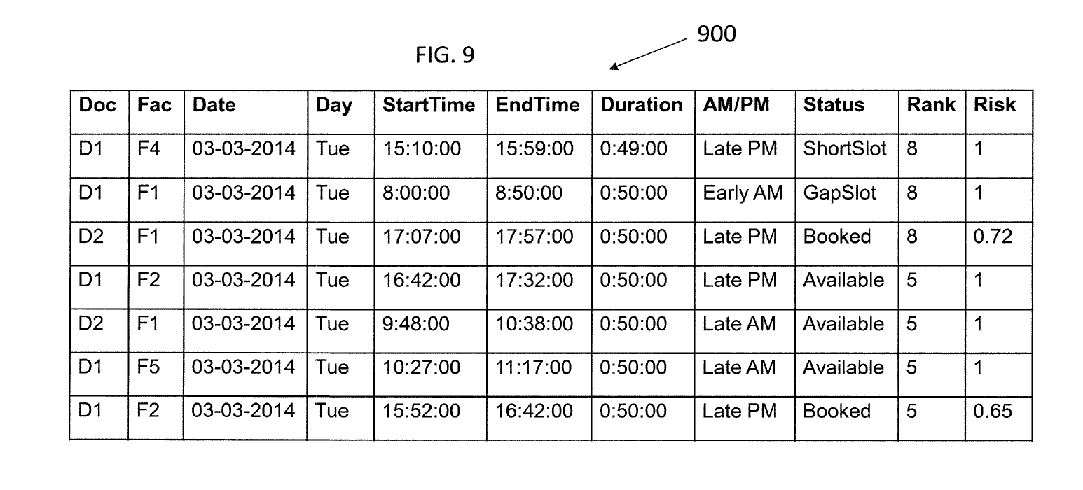

Table 900 of FIG. 9 displays the slots that are built and ranked by the computer program. The slot with highest rank is the most preferred and is presented to a patient on call. With this automation of slot generation, preferences application, and no show overbooking appointment, scheduling secretaries can greatly reduce the time they spend on calls and avoid making human errors by reading the preferences manually. Once such automation is done it is straightforward to build a waitlist to automatically fill the cancelled appointments with those far into future. Patient booking appointments in future dates can request to be added to the waitlist so that as soon as an appointment is cancelled patients can get notified to accept an appointment that got cancelled.

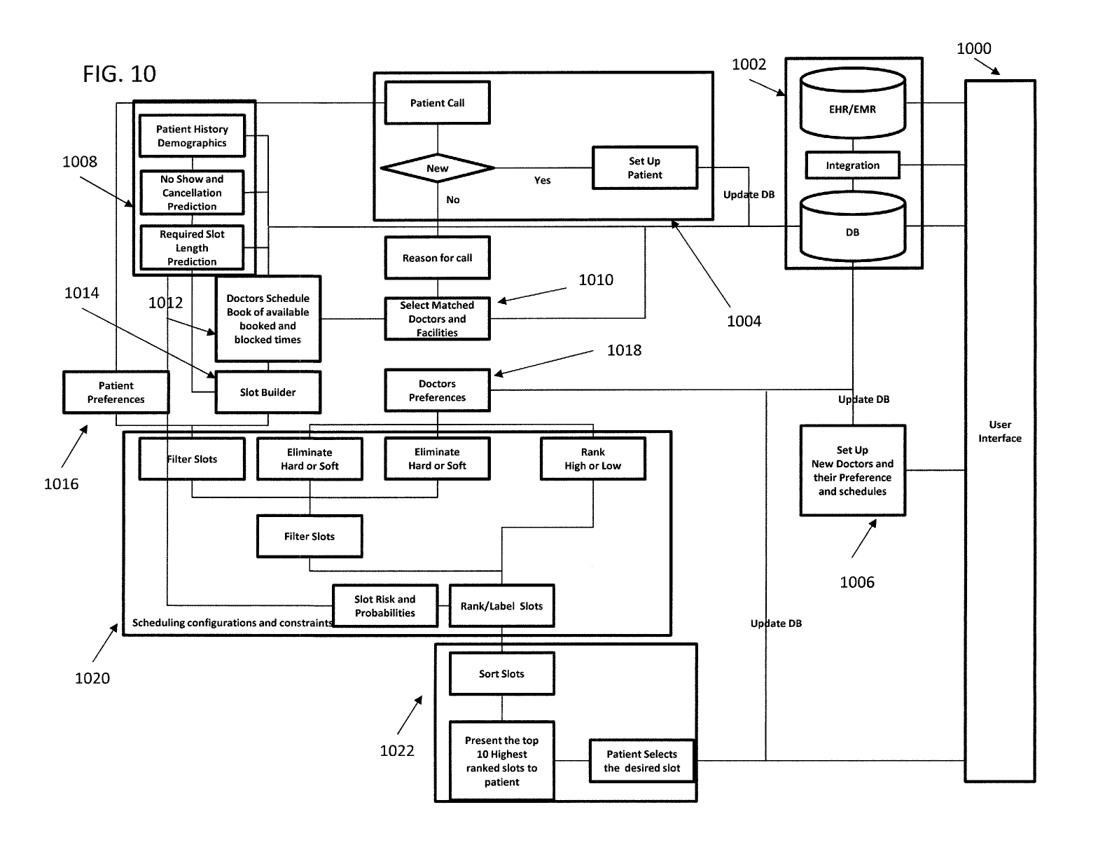

FIG. 10 shows a flow diagram illustrating the steps of a process 1000 embodying the present invention as applied to appointment scheduling. In step 1002, a set of data is either pulled or pushed for patient demographics and medical information. If the patient details already exist in the system (electronic health record and/or electronic medical records) then they are pulled out using integration APIs with the current system. If not a patient is added in step 1004. Similarly new doctor information can be added in the systems using step 1006.

In step 1008, for each patient, data related to no show and cancellation probabilities is either pulled, computed, and/or using patient demography, medical information and prediction engines. Slot length is also either predicted or used from pre-specified data.

In step 1010, for each patient, based on preferences or utility based sorting a list of doctors and facilities containing at least one doctor and one facility are prepared.

In step 1012, for each patient, appointment and schedule data is obtained for the list of doctors and facilities containing at least one doctor and one facility.

In step 1014, for each patient, for all doctors and facilities, slots of predicted lengths are generated.

In step 1016, for each patient, patient preferences are prepared for the slot filtering.

In step 1018, for each patient, all doctors' preferences are prepared for the slot ranking.

In step 1020, for each patient, all slots are filtered and ranked using the patient's preferences, doctors' preferences, and all other scheduling configurations/constraints.

Finally, in step 1022, for each patient, all slots are sorted and presented to patient for selection. This process enables all players (patients, care takers, MAs, scheduling agents, nurses, doctors, referring physicians etc.) to use the same system all across for making, cancelling, and modifying the medical appointments and update the relevant information in HER/EMR systems through integration layer in run time.

While the present invention has been disclosed in the context of various aspects of presently preferred embodiments, it will be recognized that the invention may be suitable applied to other environments consistent with the claims which follow. More particularly, while the present invention has been described in the context of a presently preferred embodiment for patients scheduling doctor appointments and the like, it will be recognized that service users more generally may benefit from scheduling appointments with service providers where issues such as no shows and late cancellation, service providers' varying acceptance of the risks of double booking, as well as, the applicability of varying appointment slot length, and the like, are considered.

I claim:

1. A computer-implemented method for computing and outputting ranked time slots for specified horizon days comprising:
electronically receiving and storing by a programmed computer a set of dates defining a horizon over which slots are to be generated analyzed;
for each day and time establishing defined windows in a week, electronically receiving and storing by the programmed computer a set of doctor's schedules;
for each day and time in the windows in the week, electronically receiving and storing by the programmed computer a set of doctor's preferences;
for each day and time in the windows in the week, electronically receiving and storing by the programmed computer a set of scheduling constraints;
for each day and time in the windows in the week, electronically receiving and storing by the programmed computer a set of scheduling configurations;
for each patient, electronically receiving and storing by the programmed computer a set of demographics and urgency data;
for each patient, electronically receiving and storing by the programmed computer a set of medical information and medical history data;
for each patient, electronically computing and storing by the programmed computer a slot length predicted for the appointment;
for each patient, electronically computing and storing by the programmed computer a no show probability;
for each patient, electronically computing and storing by the programmed computer a cancellation probability;
for each patient, electronically computing and storing by the programmed computer a set of booked and available slots;
for each patient, electronically computing and storing by the programmed computer a ranking for each booked and available slot in the set of booked and available slots; and
outputting by the programmed computer said ranking.

2. The method of claim 1 wherein the set of doctor's preferences comprise both soft and hard preferences.

3. The method of claim 1 wherein the set of scheduling constraints comprise both soft and hard constraints.

4. The method of claim 1 in which the slot length required for the requested appointment is predicted using a linear regression algorithm.

5. The method of claim 1 further comprising:
computing the no show risk using the patient demography data, medical information data, medical history data and appointment no show history data; and
computing the cancellation risk using the patient demography data, medical information data, medical history data and appointment cancellation history data.

6. The method of claim 1 further comprising:
generating slots of variable predicted lengths and filtering said generated slots using patient preferences and scheduling configurations.

7. The method of claim 1 further comprising:
ranking filtered slots of using doctors' preferences and doctors' scheduling configurations.

8. The method of claim 1 further comprising:
sorting the ranked slots in the ranking from highest to lowest and making them available to users to choose from.

9. A computer-implemented system for computing and ranking a set of medical time slots over a specified time horizon time comprising:
a memory storing data for a set of dates defining a time horizon over which slot generation and ranking is performed;
a processor executing software operating:
to retrieve data defining a set of possible doctors and facilities at each date where at least one slot can be generated from a list or book of available slots;
to retrieve data for each doctor's preferences and scheduling configurations;
to retrieve data for each patient's demography data, medical history data, and current medical information data;
to retrieve a set of facility or business level configurations to be utilized incorporating an acceptable double booking risk for an already booked slot;
to compute a set of slots, filtering conditions and ranking factors;
to sort the slots using their computed ranks from high to low; and
to electronically output the slot results utilizing an output device.

10. The system of claim 9 in which the processor further operates to generate an electronic scheduling book including sorted medical appointment time slots, a set of doctors' preferences, configurations and constraints, a set of patient's preferences, a set of facility level configurations including an acceptable double booking risk for a particular slot or slots.

11. The system of claim 9 in which the scheduling is a preferences based medical appointment scheduling and the set of supporting data includes a set of preferences both or doctors and patients, scheduling constraints and configurations, and explanatory variables to predict slot length, no show probability, and cancellation probability.

12. The system of claim 11 in which the medical time slots computed for the patients are ranked and sorted by the programmed computer.

13. A computer-implemented method comprising:
determining an estimated risk of cancellation on a patient by patient basis;
determining an acceptable level of risk of double booking on a physician by physician basis;
scheduling more than 100% of available patient appointment slots based upon a computed balancing of the estimated risk of cancellation and the acceptable level of risk of double booking.

14. The method of claim 13 further comprising:
computing variable length appointment slots on a patient by patient basis utilizing stored patient data.

15. A computer-implemented method comprising:
determining an estimated risk of cancellation on a service user by service user basis;
determining an acceptable level of risk of double booking on a service provider by service provider basis;
scheduling more than 100% of available service user appointment slots based upon a computed balancing of the estimated risk of cancellation and the acceptable level of risk of double booking.

16. The method of claim 15 further comprising:
computing variable length appointment slots on a service user by service user basis utilizing stored service user data.
